(19) United States
(12) Patent Application Publication
(10) Pub. No.: US 2012/0019015 A1
(43) Pub. Date: Jan. 26, 2012

(54) LIFT ASSIST DEVICE

(76) Inventors: Frederick E. Trader, Omaha, NE (US); Charlton J. Trader, Omaha, NE (US)

(21) Appl. No.: 13/185,340

(22) Filed: Jul. 18, 2011

Related U.S. Application Data
(60) Provisional application No. 61/366,763, filed on Jul. 22, 2010.

(51) Int. Cl. B65G 7/12

(52) U.S. Cl. 294/15

(57) ABSTRACT

The disclosure describes a novel device for providing assistance for the manual lifting of an immobile individual. The disclosure provides for a portable lift device that reduces the back strain of a caregiver and provides balance while preventing discomfort and/or injury to an immobile individual during lifting.

### INTRODUCTION

Lifting and moving individuals with limited mobility is a task performed many times each day by care providers or caregivers, such as healthcare professionals and/or family members. Unfortunately, these care providers often perform this task improperly by bending at the waist, placing their hands and arms under the individual, and titling with their arms and back. As a result, thousands of care providers each year injure their backs and/or live with chronic back pain. Further, these lifting techniques are often uncomfortable for immobile individuals and may result in immobile individual injury and/or bruising.

Mechanical lifting aids are often used in healthcare facilities to take the physical strain off of healthcare providers in an effort to prevent injuries during lifting. While enjoying modest success in institutional settings, e.g., hospitals and nursing homes, these mechanical devices are not easily transportable and are very expensive to purchase and maintain. Therefore, there is a need for an inexpensive manual lift aid that can lift and transport immobile individuals safely without causing injury and/or discomfort to the immobile individuals and/or the care providers.

### SUMMARY

The disclosure describes a novel device for providing assistance for the manual lifting of an immobile individual. The disclosure describes a portable lift device that reduces the back strain of a caregiver and provides balance while preventing discomfort and/or injury to an immobile individual during lifting.

In part, this disclosure describes a lilt assist device, including: a base portion; a first side extension portion extending from a first side of the base portion; a second side extension portion extending from a second side opposite the first side of the base portion; a balance portion extending from a third side of the base portion; a first handle attached to the first side extension portion; a second handle attached to the second side extension portion; and a third handle attached to the balance portion. The first side extension portion and the second side extension portion are configured to prevent the first and second handle from contacting an object being manually lifted and balanced in the lift assist device.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a top view of an embodiment of a lift assist device.

FIG. 2 illustrates a top view of an embodiment of a lift assist device.

FIG. 3 illustrates a side view of an embodiment of a lift assist device positioned on a chair below an immobile individual.

FIG. 4 illustrates a cross-sectional, side view of portion A as illustrated in FIG. 3.

### DETAILED DESCRIPTION

Although the device introduced and discussed in detail below may be implemented for lifting a variety of objects, the present disclosure will discuss the implementation of this device in the context of providing assistance for the lifting of a human.

Immobile individuals may have to be lifted to be moved. Often times, immobile individuals have other injuries and/or are weak, fragile, unbalanced, and/or even unconscious. While there have been several attempts to design a portable support or lifting device, these attempts fail to prevent discomfort and/or pain to immobile individuals and fail to address the needs of immobile individuals with little body control and/or other injuries.

Previous lift aids utilized material underneath the buttocks of the immobile individuals; however, these systems require the immobile individuals to either balance themselves during lifting or require the caregiver to balance the immobile individual during lifting using a free hand. Alternatively, these systems may utilize uncomfortable belts and/or harnesses to maintain the balance of the immobile individual during lifting, which have concentrated contact points on the individual. The holding of the immobile individual on the back or shoulders for balance may cause discomfort and even injury to the immobile individual during lifting, especially, if the immobile individual has injuries in this area, or is unable to express their discomfort or pain. Further, in some of these previous lift aids handles are utilized; however, these handles contact the immobile individual and create uncomfortable and painful concentrated contact points between the immobile individual and the lifting aid which could lead to injury or bruising of the immobile individual during lifting.

The lift assist device as described herein provides two side extension portions and a balance portion. These portions allow an unbalanced immobile individual to be lifted properly by caregivers (i.e., with reduced back strain) without causing discomfort and/or pain to an immobile individual. The two side extension portions and the balance portion prevent any handles from contacting the immobile individual or from having a concentrated point of contact during lifting. Further, the two side extension portions and the balance portion allow an unbalanced and/or further injured individual to be lifted without causing injury or discomfort to the immobile individual during lifting by providing a balancing support that does not require the use of belts and/or harnesses, or require manual holding of the immobile individual.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples.

While various embodiments have been described for purposes of this disclosure, various changes and modifications may be made which are well within the scope of the present disclosure. Numerous other changes may be made which will readily suggest themselves to those skilled in the art and which are encompassed in the spirit of the disclosure.

Unless otherwise indicated, all numbers expressing quantities, properties, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

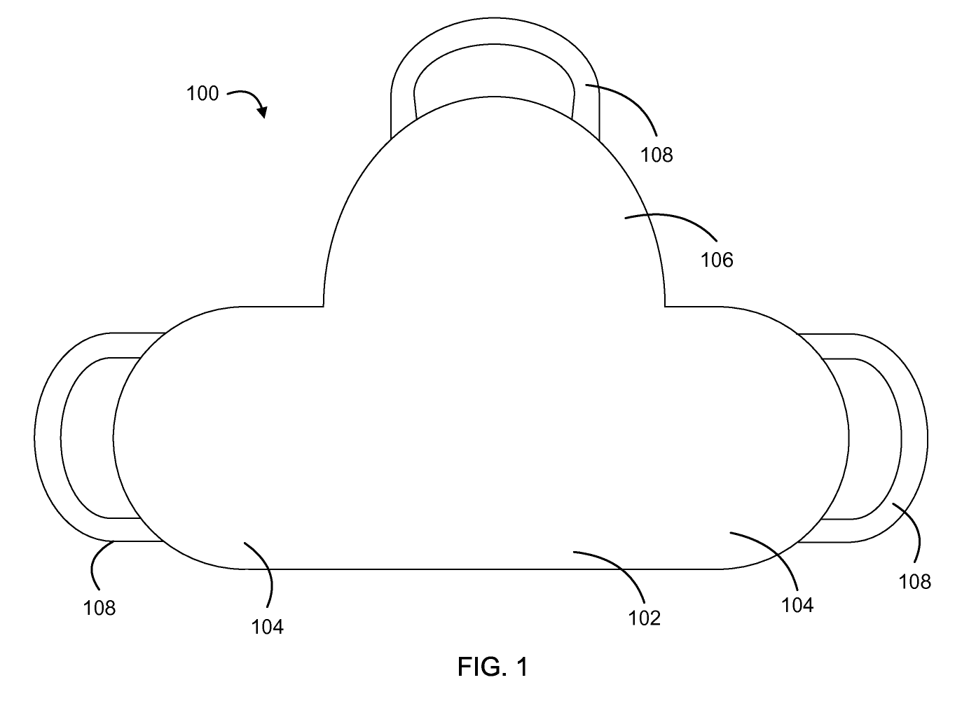

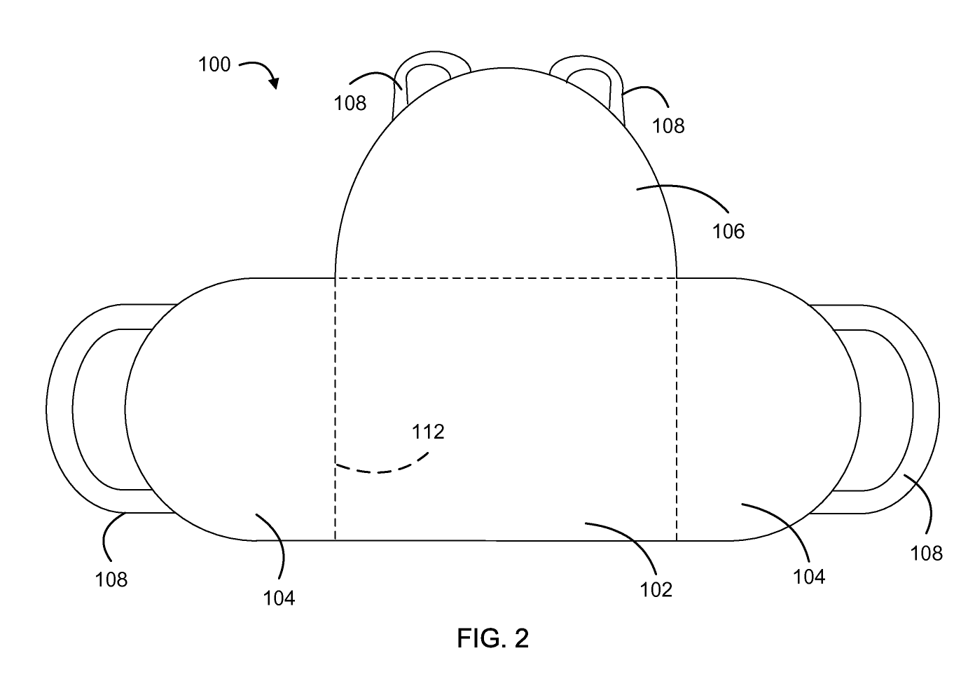

FIGS. 1-2 illustrate embodiments of a lift assist device 100. The lift assist device 100 is utilized to assist the manual lifting of an immobile individual. The lift assist device 100 is placed underneath an immobile person before lifting. The lift assist device 100 may be left underneath an immobile individual for an extended period of time for use in one or multiple liftings. The lift assist device 100 is made of any suitable flexible material for lifting and supporting an immobile individual.

In one embodiment, the flexible material of the lift assist device 100 is made of a single layer 1000 denier nylon. In another embodiment, the flexible material of the lift assist device 100 is made of a two layer or double layer of 500 denier nylon. In a further embodiment, the flexible material of the lift assist device 100 is a nylon mesh material. In another embodiment, the nylon is sold and produced by DuPont™, a company located at 1007 Market Street, Wilmington, Del. 19898. This material is particularly advantageous for repeat liftings with the same or multiple individuals because the DuPont™ denier nylon is a strong, durable, washable fabric that is hydrophobic and resists mold growth. However, any suitable material that provides these properties may be utilized in the lift assist device 100.

The lift assist device 100 includes a base portion 102, two side extension portions 104, a balance portion 106, and at least three handles 108. The base portion 102 is positioned under the buttocks of the immobile individual. The base portion 102 is the portion of the lift assist device 100 that is located underneath the immobile person during lifting.

Two side extension portions 104 extend from opposite sides of the base portion 102 or extend from a first and second opposite side of the base portion 102. A handle 108 is attached to each end of the side extension portions 104. In some embodiments, the handle 108 is positioned at the farthest point from the other side extension portion 104. These handles 108 or the first and second handles 108 are attached to side extension portions 104 by any suitable means for supporting and lifting an immobile individual, such as being stitched, glued, and/or adhered to the extension portion 104.

The side extension portions 104 are positioned during lifting to wrap around and extend past the outside portions of the legs of the immobile individual. The length of the two side extension portions 104 extend past the legs of the immobile individual. This length prevents the handle 108, located on either side extension portion 104, from contacting the immobile individual and allows both handles 108 attached to the side extension portions 104 to be grasped in one hand by the lifter or caregiver.

The flexibility of the material of the lift assist device 100 allows the two side extension portions 104 and/or a portion of the base portion 102 to bend and/or fold around the legs of the immobile individual. This fold or bend point in the fabric will change and/or adjust based on the size and shape of the immobile individual. In one embodiment, the dimensions of the base portion 102 of the lift assist device 100 are defined by this fold and/or bend point.

In an alternative embodiment, when the lift assist device 100 is formed by attaching a plurality of flexible material pieces together, a portion of the dimensions of the base portion 102 is defined by seams 112 created by the combination of these flexible material pieces as illustrated in FIG. 2. The flexibility of the attached flexible material pieces in the lift assist device 100 still allows the two side extension portions 104 to bend and/or fold around the legs of the immobile individual and/or for this fold or bend point to adjust based on the size and shape of the immobile individual.

A balance portion 106 extends from another side or a third side of the base portion 102. The balance portion 106 is positioned behind and/or underneath the back of the immobile individual prior to lifting. During lifting, the balance portion 106 provides a back support for an immobile individual during lifting. This back support prevents the caregiver or lifter from having to grab the immobile person for balancing during lifting. Further, this balance portion 106 may prevent the caregiver or lifter from having to bend at his or her back to lift the immobile individual reducing back strain on the lifter or caregiver during lifting. Also, this back support provided by the balance portion 106 prevents the need for balancing straps, belts, and/or harnesses.

While a balancing strap or harness is not necessary, in some embodiments, the lift assist device 100 may be configured to include a patient restraint device for attaching the patient to the lift assist device 100. The patient restraint device may be any suitable device, mechanism, or system for attaching a patient or an immobile individual to the lift assist device 100, such as astray system or harness device. In some embodiments, the patient restraint device includes at least one strap with a hook and loop system for attaching the patient to the lift assist device 100. In other embodiments, the patient restraint device includes straps with a clip system for attaching the patient the lift assist device 100. The patient restraint device may be attached to the lift assist device 100 via the balance portion, base portion, and/or extension portion(s) depending upon the design of the patient restraint mechanism.

Further, the back support provided by the balance portion 106 allows for a caregiver to lift an immobile individual who is unconscious or unbalanced. Additionally, the balance portion 106 distributes the support across the entire contact area of the balance portion 106, preventing discomfort or injury to an immobile individual at a point of contact for balancing the immobile individual. Further, this balance portion 106 allows immobile individuals with further injuries to their shoulders or arms to be lifted and moved with minimal contact to these injured areas.

A handle 108 or third handle 108 is attached to the end of the balance portion 106. In an alternative embodiment, two handles 108 or a third and fourth handle 108 are attached to the end of the balance portion 106, as illustrated in FIG. 2. The third and/or fourth handles 108 are attached to balance portion 106 by any suitable means for supporting and lifting the immobile individual. In some embodiments, the balance portion 106 is configured to prevent the handle 108 or handles 108 attached to the balance portion 106 from contacting the immobile individual during lifting.

The handles 108 attached to the lift assist device 100 may be made of any suitable material for lifting and supporting an immobile individual, in one embodiment, the handles 108 are made of reinforced webbing. The handles 108 may be utilized by a single lifter or caregiver to lift the immobile individual by holding the two handles 108 attached to the extension portions 104 in one hand and a handle 108 attached to the base portion 106 in his or her other hand. Further, the handles 108 may be utilized by multiple lifters or caregivers to lift the immobile individual.

In one embodiment, the lift assist device 100 is made from one piece of flexible material. In an alternative embodiment, the lift assist device 100 is made from a plurality of pieces of flexible material. In an embodiment, two pieces of flexible material are attached to each other to form the lift assist device 100, as illustrated in FIG. 2. As illustrated in FIG. 2 a first piece of material including the balance portion 106 is attached to a second piece of material including both side extension portions 104 at seams 112 to form the lift assist device 100. The overlapping portions of the two separate pieces of material form the base portion 102 of the lift assist device 100. In yet another embodiment, the material of the two pieces of material is made of a double layered 500 denier nylon. In an alternative embodiment, the material of the two pieces of material is made of a single layer 1000 denier nylon.

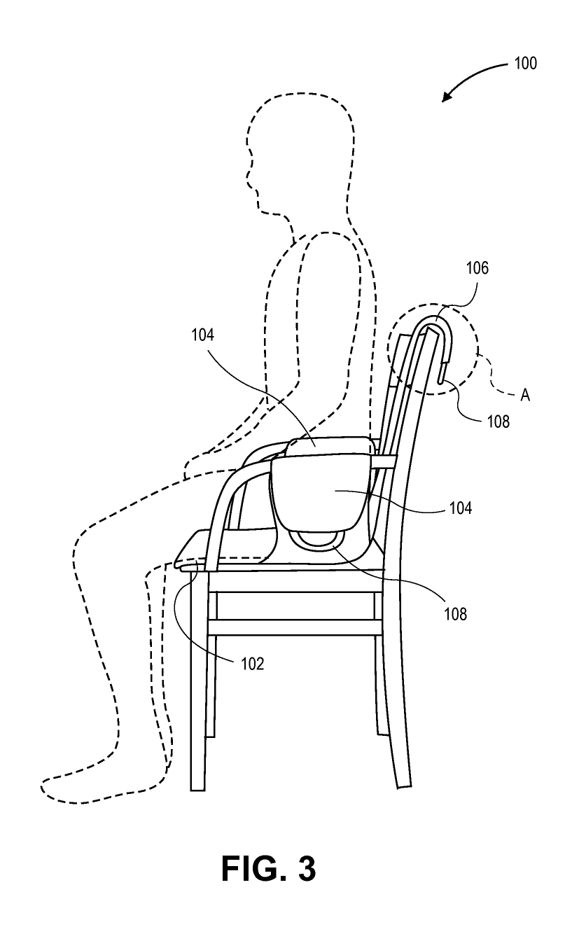

In some embodiments, the side extension portions 104 and/or the balance portion 106 are configured to extend a predetermined length from the base portion 102 of the lift assist device 100. This predetermined length allows extension portions 104 of the lift assist device 100, when the lift assist device 100 is set in a chair below an immobile individual, to extend past and fold over the arms of a chair as illustrated in FIG. 3. The predetermined length of the base portion 106 allows the base portion 106 to extend past and fold over a back of a chair when the lilt assist device 100 is set in a chair below an immobile individual as illustrated in FIG. 3. Accordingly, the predetermined length provides the caregiver with access to the handles 108 attached to the extension portion 104 and/or the balance portion 106 for lifting the immobile individual with the lift assist device 100 from a seated position in a chair. While size and shape of chairs may vary, the predetermined length of the extension portions 104 and/or base portion 106 are designed to allow access to the handles 108 for various sizes and shapes of chairs.

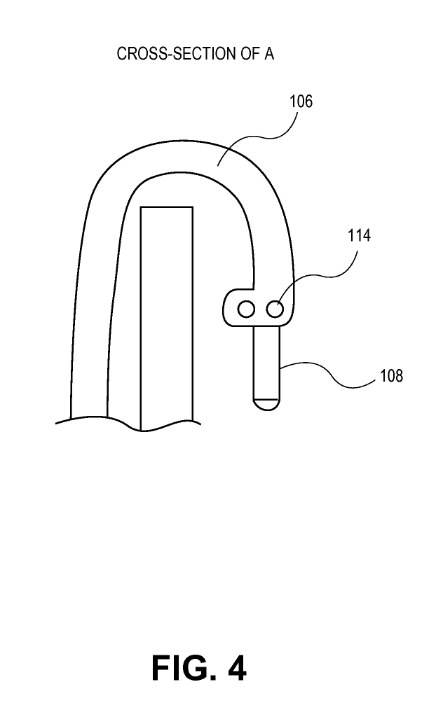

Further, in some embodiments, the handles 108 and/or the ends of the extension portions 104 and/or balance portion 106 that fold over the arms and back of a chair may include at least one weight 114, as illustrated in FIG. 4. These weights 114 may be attached to the balance portion 106, extension portions 104, and/or handles 108 by any suitable methods or systems for attaching weights 114 to a lift assist device 100. For example, the weights 114 may be sewn into the fabric, attached with a hook and loop system, strapped to the fabric, and/or slid into a created compartment. The weights 114 may be permanently attached to the lift assist device 100. In other embodiments, weights 114 are removably attached to the lift assist device 100. In these embodiments, the weights 114 provide a method or system for anchoring the extension portions 104 and/or the balance portion 106 to a chair when the lift assist device 100 is placed in a chair. The weights 114 further prevent the balance portion 106 and/or the extension portions 104 from sliding off of the back and/or arms of the chair while sitting in a chair without an immobile individual or with an immobile individual resting on top of the lift assist device 100 in the chair.

### Example Embodiment

FIG. 2 illustrates an example embodiment of a lift assist device 100. This example embodiment, demonstrates example sizing that may be utilized to form the lift assist device 100. The measurements disclosed below are merely exemplary and are in no way meant to be limiting to the disclosure. The sizes provided are example dimensions for an adult lift assist device 100.

In this embodiment, the width of the lift assist device 100 from the two farthest points from one side extension portion 104 to the other side extension portion 104 is about 35 inches. The length of the lift assist device 100 or the distance from the furthest end of the balance portion 106 to the opposite side of the base portion 102 is about 26 inches. Further, the balance portion 106 extends from the base portion 102 by about 10 inches. In this embodiment, the handles 108 are about 2 inches thick and extend about 2.5 inches from their attachment points to the opposite end of the handle 108.

Again, the sizes listed are merely exemplary. These sizes may vary for different applications, such as lift assist devices designed for children, young adults, and/or overweight individuals.

Those skilled in the art will recognize that the apparatus of the present disclosure may be implemented in many manners and as such are not to be limited by the foregoing exemplary embodiments and examples. Any number of the features of the different embodiments described herein may be combined into single or multiple embodiments, and alternate embodiments having fewer than or more than all of the features herein described are possible.

While various embodiments have been described, various changes and modifications may be made which are well within the scope of the present disclosure. Numerous other changes may be made which will readily suggest themselves to those skilled in the art and which are encompassed in the spirit of the disclosure and as defined in the claims.

What is claimed is:

1. A lift assist device, comprising:
a base portion;
a first side extension portion extending from a first side of the base portion;
a second side extension portion extending from a second side opposite the first side of the base portion;
a balance portion extending from a third side of the base portion;
a first handle attached to the first side extension portion;
a second handle attached to the second side extension portion; and
a third handle attached to the balance portion,
wherein the first side extension portion and the second side extension portion are configured to prevent the first and second handle from contacting an object being manually lifted and balanced in the lift assist device.

2. The lift assist device of claim 1, wherein the balance portion is configured to prevent the third handle from contacting an object being manually lifted and balanced in the lift assist device.

3. The lift assist device of claim 1, further comprising a fourth handle attached to the balance portion.

4. The lift assist device of claim 3, wherein the balance portion is configured to prevent the third handle and the fourth handle from contacting an object being manually lifted and balanced in the lift assist device.

5. The lift assist device of claim 1, wherein the base portion, the first side extension portion, the second side extension portion, and the balance portion are made from a single piece of material.

6. The lift assist device of claim 5, wherein the material is a single layer of 1000 denier nylon.

7. The lift assist device of claim 5, wherein the material is a double layer of 500 denier nylon.

8. The lift assist device of claim 1, wherein the base portion, the first side extension portion, the second side extension portion, and the balance portion are made from at least two pieces of attached material.

9. The lift assist device of claim 8, wherein the material is a single layer of 1000 denier nylon.

10. The lift assist device of claim 8, wherein the material is a double layer of 500 denier nylon.

11. The lift assist device of claim 1, wherein the first handle, the second handle, and the third handle are made of reinforced webbing.

12. The lift assist device of claim 1, further comprising a patient restraint device, wherein the patient restraint device is attached to at least one of the base portion, the balance portion, the first side extension portion, and the second side extension portion.

13. The lift assist device of claim 1, further comprising at least one weight attached to at least one of the balance portion, the first side extension portion, and the second side extension portion.

14. The lift assist device of claim 13, wherein the at least one weight is removable from the lift assist device.

15. The lift assist device of claim 1, wherein at least one of the balance portion, the first side extension portion, and the second side extension portion are a predetermined length.

16. The lift assist device of claim 1, further comprising at least one weight attached to at least one of the first handle, the second handle, and the third handle.

17. The lift assist device of claim 16, wherein the at least one weight is removable from the lift assist device.
